(19) United States
(12) Patent Application Publication
(10) Pub. No.: US 2012/0161085 A1
(43) Pub. Date: Jun. 28, 2012

(54) High Fire-Point Esters as Electrical Insulating Oils

(75) Inventors: Ryan J. Schexnaydre, Richmond, CA (US); John M. Rosenbaum, Richmond, CA (US); Saleh Elomari, Fairfield, CA (US); Stephen J. Miller, San Francisco, CA (US); Zhen Zhou, Emeryville, CA (US)

(73) Assignee: Chevron U.S.A. Inc., San Ramon, CA (US)

(21) Appl. No.: 12/978,064

(22) Filed: Dec. 23, 2010

(51) Int. Cl. H01B 3/20

(52) U.S. Cl. 252/572; 252/579; 252/575

(57) ABSTRACT

Provided is an electrical insulating oil formulation comprising at least one diester or triester species having ester links on adjacent carbons, and an anti-oxidant additive. The formulation exhibits an excellent balance of the pour point, viscosity and fire point properties, and is imminently suitable for use as a transformer oil.

### BACKGROUND

1. Technical Field

Provided are electrical insulating oils, and more specifically electrical insulating oils comprised of an ester species having ester links on adjacent carbons. The use of such esters can provide biodegradable electrical insulating oils having high fire points.

2. Description of the Related Art

Transformer oil or electrical insulating oil is usually a highly-refined mineral oil that is stable at high temperature and has excellent electrical insulating properties. It is used in oil-filled transformers, some types of high voltage capacitors, fluorescent lamp ballasts, and some types of high voltage switches and circuit breakers. Its functions are to insulate, suppress corona and arcing. Thus, properties of low electrical conductivity and high electrical resistivity are important.

Mineral oils, however, have poor biodegradability, and are thus a danger to the environment. Accordingly, there is a growing demand for biodegradable oils for use as insulating fluids in transformers. Hitherto, this demand has been covered by the use of sunflower oil, rapeseed oil or soybean oil. Unfortunately, these oils do not have all the necessary properties in regard to oxidation stability.

It is already well-known in the literature and in the transformer oil industry that esters are useful as electrical insulation oils in transformers. See, for example, U.S. Patent Application Publication 2008/0033201. Esters can extend the life of transformers through improved interaction with cellulosic insulation and orders of magnitude higher water saturation than traditional mineral oils. However, for the esters to become more accepted as electrical insulating oils, and transformer oils in particular, a better balance of certain properties is needed.

Specifically, the combination of high fire point (at least above 250° C., approaching 300° C.) and low pour point without dramatically increasing kinematic viscosity at 100° C. (because increasing viscosity leads to less efficient heat transfer properties) should lend itself to ester-based transformer fluids that would be more readily accepted. A good balance of such properties would better serve the industry in providing a biodegradable alternative which gives good performance.

Accordingly, providing such an electrical insulating oil formulation would be of great value to the industry, and the environment.

### SUMMARY

Provided is an electrical insulating oil formulation comprising at least one diester or triester species having ester links on adjacent carbons, and an anti-oxidant additive. The formulation exhibits an excellent balance of the pour point, viscosity and fire point properties, and is imminently suitable for use as a transformer oil.

Among other factors, the present diester and triester based electrical insulating oil formulation provides a biogradable alternative to mineral oils which also exhibits an excellent balance of physical of properties. In particular, the fire point can be quite high, at 300° C. or above, while the pour point and viscosity remain sufficiently low. The starting olefins and carboxylic acids used in preparing the diesters and triesters provide an economical manufacturing route, and also allow one to design a diester or triester product for a particular balance of properties based on the ultimate application.

### DETAILED DESCRIPTION OF THE EMBODIMENTS

As used herein, the following terms have the following meanings unless expressly stated to the contrary. While the test methods noted below are those generally used, any other test method which gives equivalent results can be used.

“Pour point,” as defined herein, represents the lowest temperature at which a fluid will pour or flow. ASTM D5950-02 (Reapproved 2007) Standard Test Method for Pour Point of Petroleum Products (Automatic Tilt Method).

“Cloud point,” as defined herein, represents the temperature at which a fluid begins to phase separate due to crystal formation. The test method for determining cloud point is ASTM D5773-10 Standard Test Method for Cloud Point of Petroleum Products (Constant Cooling Rate Method).

Kinematic Viscosity: ASTM D445-10 Standard Test Method for Kinematic Viscosity of Transparent and Opaque Liquids (and Calculation of Dynamic Viscosity).

Viscosity Index: ASTM D2270-10 Standard Practice for Calculating Viscosity Index from Kinematic Viscosity at 40 and 100° C.

Noack Volatility: ASTM D5800-10 Standard Test Method for Evaporation Loss of Lubricating Oils by the Noack Method.

Fire Point: ASTM D92-05a (Reapproved 2010) Standard Test Method for Flash and Fire Points by Cleveland Open Cup Tester.

With respect to describing molecules and/or molecular fragments herein, “Rn,” where “n” is an index, refers to a hydrocarbon group, wherein the molecules and/or molecular fragments can be linear and/or branched.

As defined herein, “Cn,” where “n” is an integer, describes a hydrocarbon molecule or fragment (e.g., an alkyl group) wherein “n” denotes the number of carbon atoms in the fragment or molecule.

The prefix “bio,” as used herein, refers to an association with a renewable resource of biological origin, such as resource generally being exclusive of fossil fuels. The term “internal olefin,” as used herein, refers to an olefin (i.e., an alkene) having a non-terminal carbon-carbon double bond (C—C). This is in contrast to “α-olefins” which do bear a terminal carbon-carbon double bond.

The term “comprising” means including the elements or steps that are identified following that term, but any such elements or steps are not exhaustive, and an embodiment can include other elements or steps.

One embodiment is directed to an electrical insulating oil composition comprising (a) a diester or triester-based electrical insulating oil derived from a biomass precursor and/or low value Fischer-Tropsch (FT) olefins and/or alcohols and (b) an anti-oxidant additive. In some embodiments, such diester or triester-based electrical insulating oils are derived from FT olefins and fatty (carboxylic) acids. In these or other embodiments, the fatty acids can be from a bio-based source (i.e., biomass, renewable source) or can be derived from FT alcohols via oxidation.

### Diester Electrical Insulating Oil Compositions

In some embodiments, the present invention is generally directed to diester-based electrical insulating oil compositions comprising a quantity of diester species having the following chemical structure:

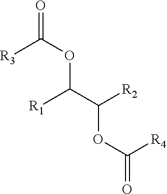

where R₁, R₂, R₃, and R₄ are the same or independently selected from a C₂ to C₁₇ carbon fragment.

Regarding the above-mentioned diester species, selection of R₁, R₂, R₃, and R₄ can follow any or all of several criteria. For example, in some embodiments, R₁, R₂, R₃, and R₄ are selected such that the kinematic viscosity of the composition at a temperature of 100° C. is typically 3 mm²/sec or greater. In some or other embodiments, R₁, R₂, R₃, and R₄ are selected such that the pour point of the resulting electrical insulating oil is −10° C. or lower, −25° C. or lower; or even −40° C. or lower. In some embodiments, R₁ and R₂ are selected to have a combined carbon number (i.e., total number of carbon atoms) of from 6 to 14. In these or other embodiments, R₃ and R₄ are selected to have a combined carbon number of from 10 to 34. Depending on the embodiment, such resulting diester species can have a molecular mass between 340 atomic mass units (a.m.u.) and 780 a.m.u.

In some embodiments, such above-described compositions are substantially homogeneous in terms of their diester component. In some or other embodiments, the diester component of such compositions comprises a variety (i.e., a mixture) of diester species.

In some embodiments, the diester-based electrical insulating oil composition comprises at least one diester species derived from a C₈ to C₁₆ olefin and a C₂ to C₁₈ carboxylic acid. Typically, the diester species are made by reacting each —OH group (on the intermediate) with a different acid, but such diester species can also be made by reacting each —OH group with the same acid.

In some of the above-described embodiments, the diester-based electrical insulating oil composition comprises a diester species selected from the group consisting of decanoic acid 2-decanoyloxy-1-hexyl-octyl ester and its isomers, tetradecanoic acid-1-hexyl-2-tetradecanoyloxy-octyl esters and its isomers, dodecanoic acid 2-dodecanoyloxy-1-hexyl-octyl ester and its isomers, hexanoic acid 2-hexanoyloxy-1-hexy-octyl ester and its isomers, octanoic acid 2-octanoyloxy-1-hexyl-octyl ester and its isomers, hexanoic acid 2-hexanoyloxy-1-pentyl-heptyl ester and isomers, octanoic acid 2-octanoyloxy-1-pentyl-heptyl ester and isomers, decanoic acid 2-decanoyloxy-1-pentyl-heptyl ester and isomers, decanoic acid-2-cecanoyloxy-1-pentyl-heptyl ester and its isomers, dodecanoic acid-2-dodecanoyloxy-1-pentyl-heptyl ester and isomers, tetradecanoic acid 1-pentyl-2-tetradecanoyloxy-heptyl ester and isomers, tetradecanoic acid 1-butyl-2-tetradecanoyloxy-hexy ester and isomers, dodecanoic acid-1-butyl-2-dodecanoyloxy-hexyl ester and isomers, decanoic acid 1-butyl-2-decanoyloxy-hexyl ester and isomers, octanoic acid 1-butyl-2-octanoyloxy-hexyl ester and isomers, hexanoic acid 1-butyl-2-hexanoyloxy-hexyl ester and isomers, tetradecanoic acid 1-propyl-2-tetradecanoyloxy-pentyl ester and isomers, dodecanoic acid 2-dodecanoyloxy-1-propyl-pentyl ester and isomers, decanoic acid 2-decanoyloxy-1-propyl-pentyl ester and isomers, octanoic acid 1-2-octanoyloxy-1-propyl-pentyl ester and isomers, hexanoic acid 2-hexanoyloxy-1-propyl-pentyl ester and isomers, and mixtures thereof.

In some embodiments, the diester-based electrical insulating oil composition further comprises a base oil selected from the group consisting of Group I oils, Group II oils, Group III oils, and mixtures thereof.

The above-described esters can also be used as blending stocks. As such, esters with higher pour points can also be used as blending stocks with other electrical insulating oils, such as other transformer oils, since they are very soluble in hydrocarbons and hydrocarbon-based oils.

### Methods of Making Diester Electrical Insulating Oils

As mentioned above, the present invention is additionally directed to methods of making the above-described electrical insulating oil compositions. The methods employed in the making of the diesters are further described in U.S. Patent Application Publications 2009/0159837 and 2009/0198075, which publications are incorporated by reference herein in their entirety.

In some embodiments, processes for making the above-mentioned diester species, typically having electrical insulating viscosity and pour point, comprise the following steps: epoxidizing an olefin (or quantity of olefins) having a carbon number of from 8 to 16 to form an epoxide comprising an epoxide ring; opening the epoxide ring to form a diol; and esterifying (i.e., subjecting to esterification) the diol with an esterifying species to form a diester species, wherein such esterifying species are selected from the group consisting of carboxylic acids, acyl acids, acyl halides, acyl anhydrides, and combinations thereof; wherein such esterifying species have a carbon number from 2 to 18; and wherein the diester species have a viscosity of 3 mm²/sec or more at a temperature of 100° C.

Furthermore, the diester species can be prepared by epoxidizing an olefin having from about 8 to about 16 carbon atoms to form an epoxide comprising an epoxide ring. The epoxidized olefin is reacted directly with an esterifying species to form a diester species, wherein the esterifying species is selected from the group consisting of carboxylic acids, acyl halides, acyl anhydrides, and combinations thereof, wherein the esterifying species has a carbon number of from 2 to 18, and wherein the diester species has a viscosity and a pour point suitable for use as an electrical insulating oil.

In some embodiments, where a quantity of such diester species is formed, the quantity of diester species can be substantially homogeneous, or it can be a mixture of two or more different such diester species.

In some such above-described method embodiments, the olefin used is a reaction product of a Fischer-Tropsch process. In these or other embodiments, the carboxylic acid can be derived from alcohols generated by a Fischer-Tropsch process and/or it can be a bio-derived fatty acid.

In some embodiments, the olefin is an α-olefin (i.e., an olefin having a double bond at a chain terminus). In such embodiments, it is usually necessary to isomerize the olefin so as to internalize the double bond. Such isomerization is typically carried out catalytically using a catalyst such as, but not limited to, crystalline aluminosilicate and like materials and aluminophosphates. See, e.g., U.S. Pat. Nos. 2,537,283; 3,211,801; 3,270,085; 3,327,014; 3,304,343; 3,448,164; 4,593,146; 3,723,564 and 6,281,404; the last of which claims a crystalline aluminophosphate-based catalyst with 1-dimensional pores of size between 3.8 Å and 5 Å.

As an example of such above-described isomerizing, Fischer-Tropsch alpha olefins (α-olefins) can be isomerized to the corresponding internal olefins followed by epoxidation. The epoxides can then be transformed to the corresponding diols via epoxide ring opening followed by di-acylation (i.e., di-esterification) with the appropriate carboxylic acids or their acylating derivatives. It is typically necessary to convert alpha olefins to internal olefins because diesters of alpha olefins, especially short chain alpha olefins, tend to be solids or waxes. “Internalizing” alpha olefins followed by transformation to the diester functionalities introduces branching along the chain which reduces the pour point of the intended products. The ester groups with their polar character would further enhance the viscosity of the final product. Adding ester branches will increase the carbon number and hence viscosity. It can also decrease the associated pour and cloud points. It is typically preferable to have a few longer branches than many short branches, since increased branching tends to lower the viscosity index (VI).

Regarding the step of epoxidizing (i.e., the epoxidation step), in some embodiments, the above-described olefin (in one embodiment an internal olefin) can be reacted with a peroxide (e.g., H₂O₂) or a peroxy acid (e.g., peroxyacetic acid) to generate an epoxide. See, e.g., D. Swern, in Organic Peroxides Vol. II, Wiley-Interscience, New York, 1971, pp. 355-533; and B. Plesnicar, in Oxidation in Organic Chemistry, Part C, W. Trahanovsky (ed.), Academic Press, New York 1978, pp. 221-253. Olefins can be efficiently transformed to the corresponding diols by highly selective reagent such as osmium tetra-oxide (M. Schroder, Chem. Rev. vol. 80, p. 187, 1980) and potassium permanganate (Sheldon and Kochi, in Metal-Catalyzed Oxidation of Organic Compounds, pp. 162-171 and 294-296, Academic Press, New York, 1981).

Regarding the step of epoxide ring opening to the corresponding diol, this step can be acid-catalyzed or based-catalyzed hydrolysis. Exemplary acid catalysts include, but are not limited to, mineral-based Brönsted acids (e.g., HCl, H₂SO₄, H₃PO₄, perhalogenates, etc.), Lewis acids (e.g., TiCl₄ and AlCl₃) solid acids such as acidic aluminas and silicas or their mixtures, and the like. See, e.g., Chem. Rev. vol. 59, p. 737, 1959; and Angew. Chem. Int. Ed., vol. 31, p. 1179, 1992. Based-catalyzed hydrolysis typically involves the use of bases such as aqueous solutions of sodium or potassium hydroxide.

Regarding the step of esterifying (esterification), an acid is typically used to catalyze the reaction between the —OH groups of the diol and the carboxylic acid(s). Suitable acids include, but are not limited to, sulfuric acid (Munch-Peterson, Org. Synth., V, p. 762, 1973), sulfonic acid (Allen and Sprangler, Org. Synth., III, p. 203, 1955), hydrochloric acid (Eliel et al., Org. Synth., IV, p. 169, 1963), and phosphoric acid (among others). In some embodiments, the carboxylic acid used in this step is first converted to an acyl chloride (via, e.g., thionyl chloride or PCl₃). Alternatively, an acyl chloride could be employed directly. Wherein an acyl chloride is used, an acid catalyst is not needed and a base such as pyridine, 4-dimethylaminopyridine (DMAP) or triethylamine (TEA) is typically added to react with an HCl produced. When pyridine or DMAP is used, it is believed that these amines also act as a catalyst by forming a more reactive acylating intermediate. See, e.g., Fersh et al., J. Am. Chem. Soc., vol. 92, pp. 5432-5442, 1970; and Hofle et al., Angew. Chem. Int. Ed. Engl., vol. 17, p. 569, 1978.

Regardless of the source of the olefin, in some embodiments, the carboxylic acid used in the above-described method is derived from biomass. In some such embodiments, this involves the extraction of some oil (e.g., triglyceride) component from the biomass and hydrolysis of the triglycerides of which the oil component is comprised so as to form free carboxylic acids.

### Triester Electrical Insulating Oil Compositions

In some embodiments, the present invention is generally directed to triester-based electrical insulating oil compositions comprising a quantity of triester species having the following chemical structure:

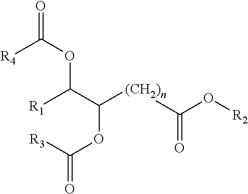

wherein R₁, R₂, R₃, and R₄ are the same or independently selected from. C₂ to C₂₀ hydrocarbon groups (groups with a carbon number from 2 to 20), and wherein “n” is an integer from 2 to 20.

Regarding the above-mentioned triester species, selection of R₁, R₂, R₃, and R₄, and n can follow any or all of several criteria. For example, in some embodiments, R₁, R₂, R₃, and R₄ and n are selected such that the kinematic viscosity of the composition at a temperature of 100° C. is typically 3 mm²/sec or greater. In some or other embodiments, R₁, R₂, R₃, and R₄ and n are selected such that the pour point of the resulting electrical insulating oil is −10° C. or lower, e.g., −25° C. or even −40° C. or lower. In some embodiments, R₁ is selected to have a total carbon number of from 6 to 12. In these or other embodiments, R₂ is selected to have a carbon number of from 1 to 20. In these or other embodiments, R₃ and R₄ are selected to have a combined carbon number of from 4 to 36. In these or other embodiments, n is selected to be an integer from 5 to 10. Depending on the embodiment, such resulting triester species can typically have a molecular mass between 400 atomic mass units (a.m.u.) and 1100 a.m.u, and more typically between 450 a.m.u. and 1000 a.m.u.

In some embodiments, such above-described compositions are substantially homogeneous in terms of their triester component. In some or other embodiments, the triester component of such compositions comprises a variety (i.e., a mixture) of such triester species. In these or other embodiments, such above-described electrical insulating oil compositions further comprise one or more diester species.

In some of the above-described embodiments, the triester-based electrical insulating oil composition comprises one or more triester species of the type 9,10-bis-alkanoyloxy-oetadecanoic acid alkyl ester and isomers and mixtures thereof, where the alkyl is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, and octadecyl; and where the alkanoyloxy is selected from the group consisting of ethanoyloxy, propanoyoxy, butanoyloxy, pentanoyloxy, hexanoyloxy, heptanoyloxy, octanoyloxy, nonaoyloxy, decanoyloxy, undacanoyloxy, dodecanoyloxy, tridecanoyloxy, tetradecanoyloxy, pentaclecanoyloxy, hexadeconoyloxy, and octadecanoyloxy, 9,10-bis-hexanoyloxy-octadecanoic acid hexyl ester and 9,10-bis-decanoyloxy-octadecanoic acid decyl ester are exemplary such triesters. In some embodiments, the triester-based electrical insulating oil composition further comprises a base oil selected from the group consisting of Group I oils. Group II oils, Group III oils, and mixtures thereof.

It is worth noting that the above-described triesters and their compositions can be used as electrical insulating oils by themselves, but can also be used as blending stocks. As such, esters with higher pour points can also be used as blending stocks with other electrical insulating oils since they are very soluble in hydrocarbons and hydrocarbon-based oils.

### Methods of Making Triester Electrical Insulating Oils

As mentioned above, the present invention is additionally directed to methods of making the above-described electrical insulating oil compositions and/or the triester compositions contained therein. Such a method is described in U.S. Pat. No. 7,544,645, which is incorporated herein by reference in its entirety.

In some embodiments, processes for making the above-mentioned triester-based compositions, typically having transformer oil viscosity and pour point, comprise the following steps: esterifying (i.e., subjecting to esterification) a mono-unsaturated fatty acid (or quantity of mono-unsaturated fatty acids) having a carbon number of from 16 to 22 with an alcohol to form an unsaturated ester (or a quantity thereof); epoxidizing the unsaturated ester to form an epoxy-ester species comprising an epoxide ring; opening the epoxide ring of the epoxy-ester species to form a dihydroxy-ester: and esterifying the dihydroxy-ester with an esterifying species to form a triester species, wherein such esterifying species are selected from the group consisting of carboxylic acids, acyl halides, acyl anhydrides, and combinations thereof; and wherein such esterifying species have a carbon number of from 2 to 19. Generally, electrical insulating oil compositions made by such methods and comprising such triester species have a viscosity of 3 mm²/sec or more at a temperature of 100° C. and they typically have a pour point of less than −20° C., and selection of reagents and/or mixture components is typically made with this objective.

In another embodiment, the method can comprise reducing a monosaturated fatty acid to the corresponding unsaturated alcohol. The unsaturated alcohol is then epoxidized to an epoxy fatty alcohol. The ring of the epoxy fatty alcohol is opened to make the corresponding triol; and then the triol is esterified with an esterifying species to form a triester species, wherein the esterifying species is selected from the group consisting of carboxylic acids, acyl halides, acyl anhydrides, and combinations thereof, and wherein the esterifying species has a carbon number of from 2 to 19. The structure of the triester prepared by the foregoing method would be as follows:

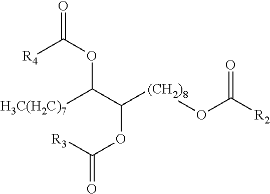

wherein R₂, R₃, and R₄ are typically the same or independently selected from C₂ to C₂₀ hydrocarbon groups, and are more typically selected from C₄ to C₁₂ hydrocarbon groups.

In another embodiment, the method can comprise reducing a monosaturated fatty acid to the corresponding unsaturated alcohol; epoxidizing the unsaturated alcohol to an epoxy fatty alcohol; and esterifying the fatty alcohol epoxide with an esterifying species to form a triester species, wherein the esterifying species is selected from the group consisting of carboxylic acids, acyl halides, acyl anhydrides, and combinations thereof, and wherein the esterifying species has a carbon number of from 2 to 19.

In some embodiments, where a quantity of such triester species is formed, the quantity of triester species can be substantially homogeneous, or it can be a mixture of two or more different such triester species. In any such embodiments, such triester compositions can be further mixed with one or more base oils of the type Group I-III. Additionally or alternatively, in some embodiments, such methods further comprise a step of blending the triester composition(s) with one or more diester species.

In some embodiments, such methods produce compositions comprising at least one triester species of the type 9,10-bis-alkanoyloxy-octadecanoic acid alkyl ester and isomers and mixtures thereof where the alkyl is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, and octadecyl; and where the alkanoyloxy is selected from the group consisting of ethanoyloxy, propanoyoxy, butanoyloxy, pentanoyloxy, hexanoyloxy, heptanoyloxy, octanoyloxy, nonaoyloxy, decanoyloxy, undacanoyloxy, dodecanoyloxy, tridecanoyloxy, tetradecanoyloxy, pentadecanoyloxy, hexadeconoyloxy, and octadecanoyloxy. Exemplary such triesters include, but not limited to, 9,10-bis-hexanoyloxy-octadecanoic acid hexyl ester; 9,10-bis-octanoyloxy-octadecanoic acid hexyl ester; 9,10-bis-decanoyloxy-octadecanoic acid hexyl ester; 9,10-bis-dodecanoyoxy-octadecanoic acid hexyl ester; 9,10-bis-hexanoyloxy-octadecanoic acid decyl ester; 9,10-bis-decanoyloxy-octadecanoic acid decyl ester; 9,10-bis-octanoyloxy-octadecanoic acid decyl ester; 9,10-bis-dodecanoyloxy-octadecanoic acid decyl ester; 9,10-bis-hexanoyloxy-octadecanoic acid octyl ester; 9,10-bis-octanoyloxy-octadecanoic acid octyl ester: 9,10-bis-decanoyloxy-octadecanoic acid octyl ester; 9,10-bis-dodecanoyloxy-octadecanoic acid octyl ester; 9,10-bis-hexanoyloxy-octadecanoic acid dodecyl ester; 9,10-bis-octanoyloxy-octadecanoic acid dodecyl ester; 9,10-bis-decanoyloxy-octadecanoic acid dodecyl ester; 9,10-bis-doclecanoyloxy-octadecanoic acid dodecyl ester; and mixtures thereof.

In some such above-described method embodiments, the mono-unsaturated fatty acid can be a bio-derived fatty acid. In some or other such above-described method embodiments, the alcohol(s) can be FT-produced alcohols.

In some such above-described method embodiments, the step of esterifying (i.e., esterification) the mono-unsaturated fatty acid can proceed via an acid-catalyzed reaction with an alcohol using, e.g., H₂SO₄ as a catalyst. In some or other embodiments, the esterifying can proceed through a conversion of the fatty acid(s) to an acyl halide (chloride, bromide, or iodide) or acyl anhydride, followed by reaction with an alcohol.

Regarding the step of epoxidizing (i.e., the epoxidation step), in some embodiments, the above-described mono-unsaturated ester can be reacted with a peroxide (e.g., H₂O₂) or a peroxy acid (e.g., peroxyacetic acid) to generate an epoxy-ester species. See, e.g., D. Swern, in Organic Peroxides Vol. II, Wiley-Interscience, New York, 1971, pp. 355-533; and B. Plesnicar, in Oxidation in Organic Chemistry, Part C, W. Trahanovsky (ed.), Academic Press, New York 1978, pp. 221-253. Additionally or alternatively, the olefinic portion of the mono-unsaturated ester can be efficiently transformed to the corresponding dihydroxy ester by highly selective reagents such as osmium tetra-oxide (M. Schroder, Chem. Rev. vol. 80, p. 187, 1980) and potassium permanganate (Sheldon and Kochi, in Metal-Catalyzed Oxidation of Organic Compounds, pp. 162-171 and 294-296, Academic Press, New York, 1981).

Regarding the step of epoxide ring opening to the corresponding dihydroxy-ester, this step is usually an acid-catalyzed hydrolysis. Exemplary acid catalysts include, but are not limited to, mineral-based Brönsted acids (e.g., HCl, H₂SO₄, H₃PO₄, perhalogenates, etc.), Lewis acids (e.g., TiCl₄ and AlCl₃), solid acids such as acidic aluminas and silicas or their mixtures, and the like. See, e.g., Chem. Rev. vol. 59, p. 737, 1959; and Angew. Chem. Int. Ed., vol. 31, p. 1179, 1992. The epoxide ring opening to the diol can also be accomplished by base-catalyzed hydrolysis using aqueous solutions of KOH or NaOH.

Regarding the step of esterifying the dihydroxy-ester to form a triester, an acid is typically used to catalyze the reaction between the —OH groups of the diol and the carboxylic acid(s). Suitable acids include, but are not limited to, sulfuric acid (Munch-Peterson, Org. Synth., V, p. 762, 1973), sulfonic acid (Allen and Sprangler, Org. Synth., III, p. 203, 1955), hydrochloric acid (Eliel et al., Org. Synth., IV, p. 169, 1963), and phosphoric acid (among others). In some embodiments, the carboxylic acid used in this step is first converted to an acyl chloride (or another acyl halide) via, e.g., thionyl chloride or PC13. Alternatively, an acyl chloride (or other acyl halide) could be employed directly. Where an acyl chloride is used, an acid catalyst is not needed and a base such as pyridine, 4-dimethylaminopyridine (DMAP) or triethylamine (TEA) is typically added to react with an HCl produced. When pyridine or DMAP is used, it is believed that these amines also act as a catalyst by forming a more reactive acylating intermediate. See, e.g., Fersh et al., J. Am. Chem. Soc., vol. 92, pp. 5432-5442, 1970; and Hofle et al., Angew. Chem. Int. Ed. Engl., vol. 17, p. 569, 1978. Additionally or alternatively, the carboxylic acid could be converted into an acyl anhydride and/or such species could be employed directly.

Regardless of the source of the mono-unsaturated fatty acid, in some embodiments, the carboxylic acids (or their acyl derivatives) used in the above-described methods are derived from biomass. In some such embodiments, this involves the extraction of some oil (e.g., triglyceride) component from the biomass and hydrolysis of the triglycerides of which the oil component is comprised so as to form free carboxylic acids.

In some particular embodiments, wherein the above-described method uses oleic acid for the mono-unsaturated fatty acid, the resulting triester is of the type:

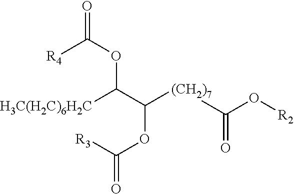

wherein R₂, R₃ and R₄ are typically the same or independently selected from C₂ to C₂₀ hydrocarbon groups, and are more typically selected from C₄ to C₁₂ hydrocarbon groups.

Using a synthetic strategy in accordance with that outlined above, oleic acid can be converted to triester derivatives (9,10-bis-hexanoyloxy-octadecanoic acid hexyl ester) and (9,10-bis-decanoyloxy-octadecanoic acid decyl ester). Oleic acid is first esterified to yield a mono-unsaturated ester. The mono-unsaturated ester is subjected to an epoxidation agent to give an epoxy-ester species, which undergoes ring-opening to yield a dihydroxy ester, which can then be reacted with an acyl chloride to yield a triester product.

The strategy of the above-described synthesis utilizes the double bond functionality in oleic acid by converting it to the diol via double bond epoxidation followed by epoxide ring opening. Accordingly, the synthesis begins by converting oleic acid to the appropriate alkyl oleate followed by epoxidation and epoxide ring opening to the corresponding diol derivative (dihydroxy ester).

Variations (i.e., alternate embodiments) on the above-described electrical insulating oil compositions include, but are not limited to, utilizing mixtures of isomeric olefins and or mixtures of olefins having a different number of carbons. This leads to diester mixtures and triester mixtures in the product compositions.

Variations on the above-described processes include, but are not limited to, using carboxylic acids derived from FT alcohols by oxidation.

The electrical insulating oils of the present invention, which can comprise at least one of the FT derived or bio-mass derived diesters or triesters as the base oil, should have a viscosity and pour point which is suitable for an electrical insulating oil and, e.g., transformer oil. In one embodiment, the pour point is not greater than −10° C., not greater than −25° C., or not greater than −40° C. It is desirable to have a pour point greater than −10° C. in order to prevent the oils from solidifying at a low temperature. Further, the transformer oils in one embodiment have a kinematic viscosity of not less than 2 mm²/sec, and can be in the range of from 2-8 mm²/sec, or in the range of from 2-6 mm²/sec.

In addition to some type of mineral oil and/or ester, a typical transformer oil formulation contains an antioxidant. Other conventional additives, which might be used include a pour point depressant (if the base fluid has a high pour point), an additive to reduce gassing tendency, and a metal deactivator (e.g., copper or steel passivator). If the base fluid is strictly an ester, it likely will have sufficiently low gassing tendency already and will also not need a metal deactivator because it has no sulfur content.

The present electrical insulating oils are very well suited for use in a transformer. The high fire point of the diesters or triestes allow safe use in transformers. The fire point exhibited is generally at least 200° C., in one embodiment at least 250° C., and in another embodiment at least 300° C. The pour point can be designed to be quite low in order to allow use for outdoor transformers. For example, the pour point can be −10° C. or lower, in one embodiment −25° C. or lower, and in another embodiment −40° C. or lower. The viscosity is also appropriate, and the kinematic viscosity is generally in the range of from 2-8 mm²/sec at 100° C., and in one embodiment in the range of from 2-6 mm²/sec at 100° C. For use in transformers, and in general, the diesters are preferred for economic reasons and ease of manufacture.

### EXAMPLES

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

Four diesters, A, B, C and D, were prepared using the following olefins and carboxylic acids in accordance with the present process. The specific procedure for preparing diester A was as follows:

Tetradecenes were epoxidized as follows using a general procedure for the epoxidation of 7,8-tetradecene. To a stirred solution of 143 grams (0.64 mole) of 77% mCPBA (meta-chloroperoxybenzoic acid) in 500 mL chloroform, 100 grams (0.51 mol) of 7,8-tetradecene in 200 mL chloroform was added dropwise over a 45-minute period. The resulting reaction mixture was stirred overnight. The resulting milky solution was subsequently filtered to remove meta-chloro-benzoic acid that formed therein. The filtrate was then washed with a 10% aqueous solution of sodium bicarbonate. The organic layer was dried over anhydrous magnesium sulfate and concentrated on a rotary evaporator. The reaction afforded the desired epoxide (isomers of n-tetradecene epoxides) as colorless oil in 93% yield.

The isomers of n-tetradecene epoxides (10.6 grams, 50 mmol) were mixed with lauric acid (30 grams, 150 mmol) and 85% H3PO4 (0.1 grains, 0.87 mmol). The mixture was stirred and bubbled/purged with nitrogen at 150° C. for 20 hours. Excess lauric acid was removed from the product first by recrystallization in hexane with subsequent filtration at −15° C., and then by adding a calculated amount of 1N NaOH solution and filtering out the sodium laurate salt. The diester product collected (21.8 grams, 73% yield) was a light yellow, transparent oil. The oil comprised a mixture of diester species.

Diesters B, C and D were prepared using a similar procedure, but with the olefins and carboxylic acids noted below.

| Ester | Starting material-Olefin | Starting material-acid |
|---|---|---|
| A | C14 alpha olefin | Lauric acid |
| B | C14 alpha olefin | C6-C10 fatty acids |
| C | isomerized C16 olefin | Lauric acid |
| D | isomerized C16 olefin | C6-C10 fatty acids |

The physical properties of the diesters were measured, and are set forth in the following table:

| Property/Sample | D | B | A | C |
|---|---|---|---|---|
| KV100, mm²/sec | 4.545 | 4.191 | 4.76 | 5.217 |
| KV40, mm²/sec | 21.54 | 19.47 | 19.5 | 24.44 |
| Viscosity Index (VI) | 127 | 120 | 176 | 152 |
| Pour point, ° C. | −51 | −60 | −27 | −19 |
| Fire point, ° C. | 228 | 226 | 280 | 290 |
| Noack volatility, % loss | 6.3 | 9.1 | — | — |

From the foregoing, a good combination of properties can be seen for the diesters, making them useful in a transformer, as well as for other applications of electrical insulating oils. The fire point is high and the pour points and viscosity at 100° C. are low.

Various modifications and alterations of this invention will become apparent to those skilled in the art without departing from the scope and spirit of the invention. Other objects and advantages will become apparent to those skilled in the art from a review of the preceding description.

That which is claimed is:

1. An electrical insulating oil formulation comprising at least one diester or triester species having ester links on adjacent carbons, and an anti-oxidant additive.

2. The electrical insulating oil formulation of claim 1, wherein the formulation comprises a diester species.

3. The electrical insulating oil formulation of claim 2, wherein the diester species has the following structure: 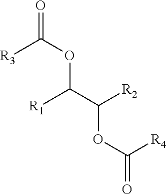
wherein R₁, R₂, R₃ and R₄ are the same or independently selected from hydrocarbon groups having from 2 to 17 carbon atoms.

4. The electrical insulating oil formulation of claim 2, wherein the diester species is derived from a process comprising:
a) epoxidizing an olefin having from about 8 to about 16 carbon atoms to form an epoxide comprising an epoxide ring;
b) opening the epoxide ring of step a) and forming a diol;
c) esterifying the diol of step b) with an esterifying species to form a diester species, wherein the esterifying species is selected from the group consisting of carboxylic acids, acyl halides, acyl anhydrides, and combinations thereof, wherein the esterifying species has a carbon number of from 2 to 18, and wherein the diester species has a viscosity and a pour point suitable for use as an electrical insulating oil.

5. The electrical insulating oil formulation of claim 2, wherein the diester species is derived from a process comprising:
a) epoxidizing an olefin having from about 8 to about 16 carbon atoms to form an epoxide comprising an epoxide ring; and
b) reacting the epoxidized olefin with an esterifying species to form a diester species, wherein the esterifying species is selected from the group consisting of carboxylic acids, acyl halides, acyl anhydrides, and combinations thereof, wherein the esterifying species has a carbon number of from 2 to 18, and wherein the diester species has a viscosity and a pour point suitable for use as an electrical insulating oil.

6. The electrical insulating oil formulation of claim 1, wherein the formulation comprises a triester species.

7. The electrical insulating oil formulation of claim 6, wherein the triester species has the following structure: 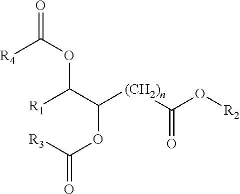
wherein R₁, R₂, R₃ and R₄ are the same or independently selected from hydrocarbon groups having from 2 to 20 carbon atoms and wherein “n” is an integer from 2 to 20.

8. The electrical insulating oil formulation of claim 6, wherein the triester species has the following structure: 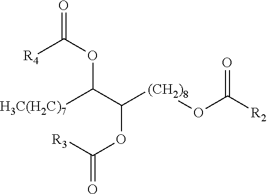
wherein R₂, R₃, and R₄ are typically the same or independently selected from C₂ to C₂₀ hydrocarbon groups.

9. The electrical insulating oil formulation of claim 6, wherein the triester species is derived from a process comprising:
a) esterifying a mono-unsaturated fatty acid having from 10 to 22 carbon atoms with an alcohol thereby forming an unsaturated ester;
b) epoxidizing the unsaturated ester in step a) thereby forming an epoxy-ester species comprising an epoxide ring;
c) opening the ring of the epoxy-ester species in step b) thereby forming a dihydroxy ester; and
d) esterifying the dihydroxy ester in step c) with an esterifying species to form a triester species, wherein the esterifying species is selected from the group consisting of carboxylic acids, acyl halides, acyl anhydrides, and combinations thereof, and wherein the esterifying species has a carbon number of from 2 to 19.

10. The electrical insulating oil formulation of claim 6, wherein the triester species is derived from a process comprising:
a) reducing a monosaturated fatty acid to the corresponding unsaturated alcohol;
b) epoxidizing the unsaturated alcohol to an epoxy fatty alcohol;
c) opening the ring of the epoxy fatty alcohol to make the corresponding triol; and
d) esterifying the triol of step c) with an esterifying species to form a triester species, wherein the esterifying species is selected from the group consisting of carboxylic acids, acyl halides, acyl anhydrides, and combinations thereof, and wherein the esterifying species has a carbon number of from 2 to 19.

11. The electrical insulating oil formulation of claim 6, wherein the triester species is derived from a process comprising:
a) reducing a monosaturated fatty acid to the corresponding unsaturated alcohol;
b) epoxidizing the unsaturated alcohol to an epoxy fatty alcohol;
c) esterifying the fatty alcohol epoxide with an esterifying species to form a triester species, wherein the esterifying species is selected from the group consisting of carboxylic acids, acyl halides, acyl anhydrides, and combinations thereof, and wherein the esterifying species has a carbon number of from 2 to 19.

12. The electrical insulating oil formulation of claim 1, wherein the oil is a transformer oil.

13. The electrical insulating oil formulation of claim 1, wherein the oil exhibits a fire point of at least 200° C.

14. The electrical insulating oil formulation of claim 1, wherein the oil exhibits a fire point of at least 250° C.

15. The electrical insulating oil formulation of claim 1, wherein the oil exhibits a fire point of at least 300° C.

16. The electrical insulating oil formulation of claim 1, wherein the oil has a pour point of −40° C. or lower.

17. The electrical insulating oil formulation of claim 1, wherein the oil has a pour point of −25° C. or lower.

18. The electrical insulating oil formulation of claim 1, wherein the oil has a pour point of −10° C. or lower.

19. The electrical insulating oil formulation of claim 1, wherein the oil formulation has a kinematic viscosity in the range of 2-8 mm²/sec at 100° C.

20. The electrical insulating oil formulation of claim 1, wherein the oil formulation has a kinematic viscosity in the range of 2-6 mm²/sec at 100° C.

21. The electrical insulating oil formulation of claim 4, wherein the esterifying species is a carboxylic acid.

22. The electrical insulating oil formulation of claim 21, wherein the carboxylic acid is derived from a bio-derived fatty acid.

23. The electrical insulating oil formulation of claim 21, wherein the wherein the carboxylic acid is derived from alcohols generated by a Fischer-Tropsch process.

24. The electrical insulating oil formulation of claim 1, further comprising a copper passivator additive.

25. The electrical insulating oil formulation of claim 1, further comprising a pour point depressant.

26. The electrical insulating oil formulation of claim 1, wherein the antioxidant additive is a phenolic or amine antioxidant.

27. The electrical insulating oil formulation of claim 1, wherein the formulation comprises a mixture of diester and triester species.
